(19) United States
(12) Patent Application Publication
(10) Pub. No.: US 2026/0100296 A1
(43) Pub. Date: Apr. 9, 2026

(54) CABLES HAVING LONGITUDINALLY WRAPPED, SPLICED TAPE AND METHODS OF FORMING THE SAME

(71) Applicant: Prysmian S.p.A., Milano (IT)

(72) Inventors: Robert Martin, Nicholasville, KY (US); Stephen A. Thwaites, Walton, KY (US)

(21) Appl. No.: 18/906,570

(22) Filed: Oct. 4, 2024

(51) Int. Cl. H01B 7/22; H01B 13/10

(52) U.S. Cl. CPC H01B 7/225; H01B 13/10

(57) ABSTRACT

Cables having shield tape layer are disclosed. The shield tape layer surrounds a cable core and is longitudinally applied to the cable core such that an overlapping region extends along a length of the cable. Successive strips of shield tape that form the shield tape layer are connected by one or more strips of splice tapes. Methods of making the cables are further disclosed.

### TECHNICAL FIELD

The present disclosure generally relates to cables having a longitudinally wrapped, spliced tape and methods of forming the same. The present disclosure further relates to a nonoverlapping joint for longitudinally wrapped tape for a cable.

### BACKGROUND

Longitudinally applied tape layers for cables are needed for various reasons. For example, in local area network (LAN) cables, such tapes can be used as a barrier to alien crosstalk and other noise transfer. In forming such cables, tape strips must be spliced by a joint. Conventional tapes use a joint that spans the entire width of the tape, but this causes an increase in thickness for the overlapping regions of the tape. Such thickness increase can result in breakages when the joint passes through a tape former. There remains a need for cables having a splice tape that can effectively join tape strips while allowing for efficient production the same.

GB Patent No. 1295624 describes a cable having two overlapping tapes wrapped around the same as a shield or moisture barrier, where each tape includes a broad metal strip with a plastic coating. Metal tangs are provided as the metal strips or a metal connector, where the tangs are in contact with adjacent metal strips and pierce the insulation. The metal connector, having the same width as the metal strips, may be formed from aluminum with a plastic coating, while the metal strips may be formed from aluminum with a coating of a copolymer of polythene with reactive carboxyl groups.

U.S. Pat. No. 6,481,664 describes an automatic tape crossover machine having two feeding mechanisms to supply running tapes and new tapes, respectively. A running tape is fed from a first tape feeding mechanism and passes through a powered cutter and is cut in response to a cut signal. A new tape is joined to the running tape at a joining mechanism, in response to a join signal. Specifically, control circuitry automatically determines whether a tape exhaustion condition has been reached and provides the join and cut signals to join the running and new tapes and to cut the running tape, before the tape feeding mechanism is emptied of the running tape, such that there is an automatic transition from the running tape to the new tape.

### SUMMARY

In accordance with one embodiment, a cable includes a cable core including one or more conductors; and a shield tape layer including two or more strips of shield tape surrounding the cable core, wherein the strips of shield tape are longitudinally applied to the cable core such that an overlapping region extends along a length of the cable; and one or more strips of splice tape, each of the one or more strips of splice tape connecting successive strips of shield tape and being sized such that the one or more strips of splice tapes do not extend into the overlapping region of the shield tape layer.

In accordance with another embodiment, a method of forming a cable includes providing a cable core including one or more conductors; longitudinally wrapping two or more strips of shield tape around the cable core such that an overlapping region extends along a length of the cable; and connecting successive strips of the two or more strips of shield tape with one or more strips of splice tape, each of the one or more strips of splice tape being sized such that the one or more strips of splice tape do not extend into the overlapping region of the shield tape layer.

### BRIEF DESCRIPTION OF THE DRAWINGS

FIG. 1 depicts a perspective view of a cable with two strips of shield tape connected by a splice tape, according to the prior art;

FIG. 2 depicts a top view of the two strips of shield tape and the splice tape of FIG. 1, where the two strips of shield tape are connected by the splice tape;

FIG. 3 depicts a cross-sectional view of the cable of FIG. 1, along line 3-3;

FIG. 4 depicts a perspective view of a cable with strips of shield tape connected by a splice tape, in accordance with one embodiment;

FIG. 5 depicts a top view of the two strips of shield tape and the splice tape of FIG. 4, where the two strips of shield tape are connected by the splice tape;

FIG. 6 depicts a cross-sectional view of the cable of FIG. 4, along line 6-6; and

FIG. 7 depicts a top view of two strips of shield tape and a splice tape, in accordance with one embodiment.

### DETAILED DESCRIPTION

Shield tape layers for cables are often longitudinally wrapped around a core (e.g., one or more conductors) forming an overlapping region that extends along the length of the cable. While splice tape used to connect successive strips of shield tape typically maximize coverage of each strip by spanning an entire width thereof, it has been presently discovered that splice tape covering less than the width of such strips are desirable and can reduce the overall size of the cable and prevent breakages during formation of the same.

As can be appreciated, a “width” of the shield tape or splice tape, as used herein, can refer to a measurement from one side of the shield tape or splice tape to the other side in a direction that is perpendicular or substantially perpendicular to the longitudinal direction of the shield tape. Similarly, a “width” of the shield tape layer or a portion thereof (e.g., overlapping region), as integrated within the cables described herein, can refer to a measurement from one point to another point along the circumference of the shield tape layer.

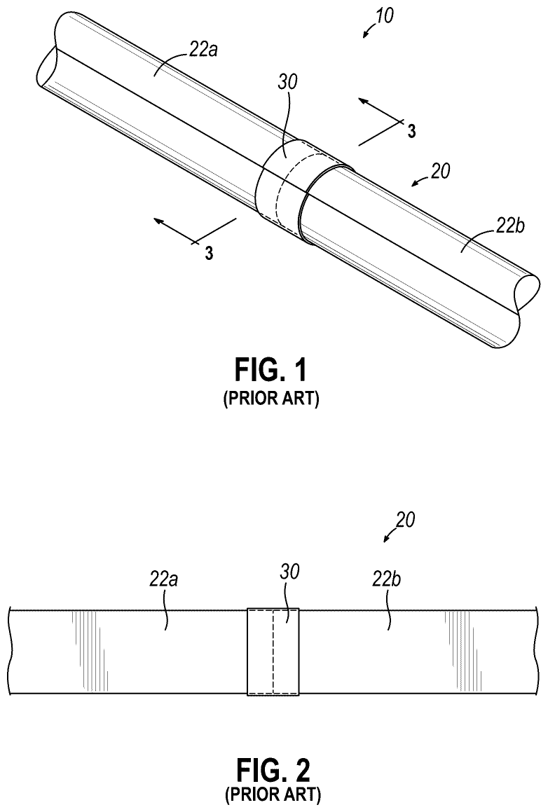

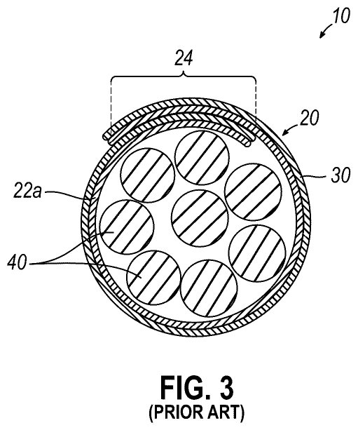

The improved splice tape described herein can be sized such that the splice tape does not extend into an overlapping region of a shield taper layer. FIGS. 1-3 depict a shield tape layer 20 configuration for cables 10 in the prior art. Specifically, two strips of shield tape 22a, 22b are shown to be joined by a splice tape 30. Conventional splice tape 30 generally covers the entirety of the shield tape (e.g., 22a, 22b) across a width of the same, as such splice tape 30 has a width equal to that of the shield tape (e.g., 22a, 22b). As a result, the splice tape 30 of such prior art cables 10 is rolled into overlapping region 24 of the shield tape layer 20, as best shown in FIG. 3, such that a thickness of the shield tape layer 20 at the overlapping region 24 is two times a thickness of the shield tape (e.g., 22a, 22b) plus two times a thickness of the splice tape 30. Thus, inclusion of the splice tape 30 within an overlapping region 24 of the shield tape layer 20 has resulted in an increased cable diameter and unnecessary bulk for conventional cables 10. This increased thickness of the shield tape layer 20 at the overlapping region 24 can cause breakages in, for example, the shield tape layer 20 or a jacket layer (not shown).

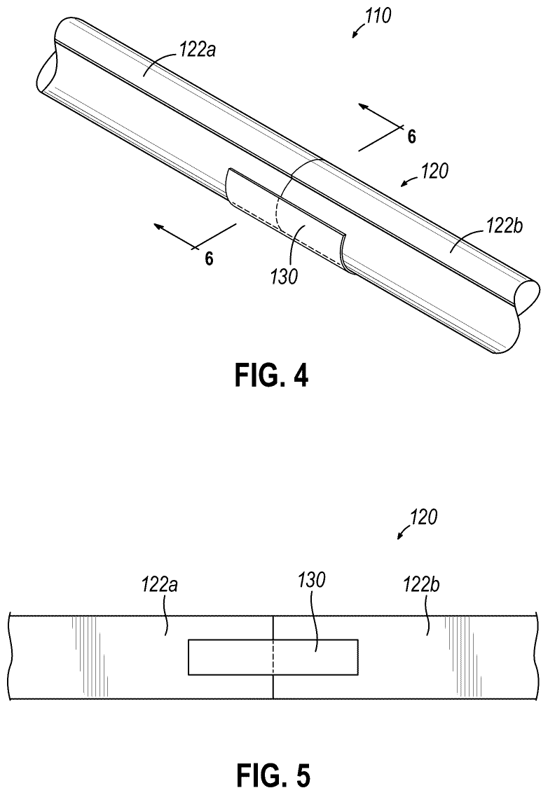

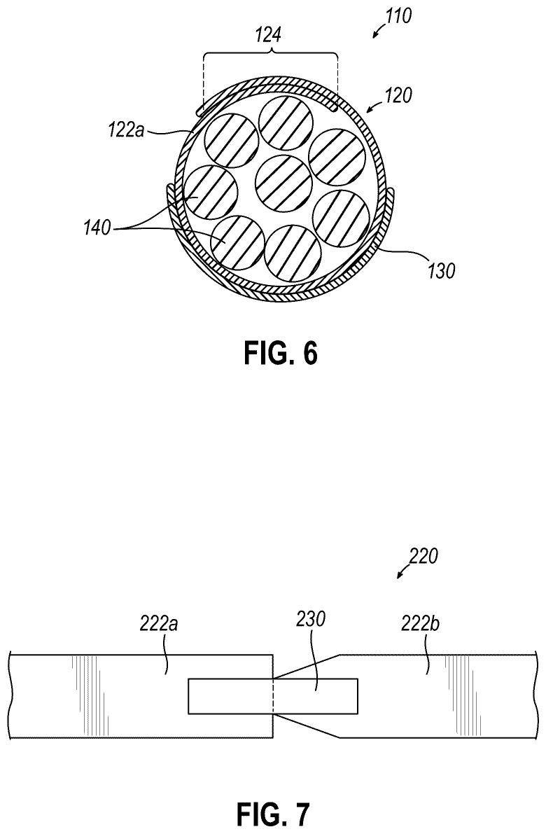

Referring to FIGS. 4-6, improved cables 110 can include conductors 140 (i.e., pairs of twisted conductors) surrounded by a shield tape layer 120 formed from strips of shield tape 122a, 122b connected by improved splice tape 130. As shown by FIG. 5, for example, the improved splice tape 130 spans only a region of a width of the strips of shield tape (e.g., 122a, 122b). The narrower width of the improved splice tape 130 can reduce the bulk and diameter of the cable 110. For example, as shown in FIGS. 4 and 6, in which the shield tape layer is shown to be wrapped around the conductors 140, the overlapping region 124 of the shield tape layer 120 does not include any region of the splice tape 130. Thus, a thickness of the shield tape layer 120 at the overlapping region 124 is only two times the thickness of a shield tape (e.g., 122a, 122b). As a result of the size reduction of the shield tape layer 120, tape breaks can be reduced by implementation of improved splice tape 130.

The improved cables 110 can include any of a variety of suitable cables that employ a shield tape layer 120. For example, suitable types of cables can include LAN cables and data communication cables. Such data communication cables can meet the standards of ANSI/TIA 568.2-D (2018) of the American National Standards Institute (“ANSI”) and the Telecommunications Industry Association (“TIA”) for Category 5e, Category 6, Category 6A, Category 7, Category 7A, and Category 8 cables. In certain embodiments, the cables can be Category 6A cables.

The improved cables 110 can include a cable core having one or more conductors 140. In certain embodiments, and as shown in FIG. 6, the cable core can include pairs of twisted conductors. In such embodiments, each of the twisted wire pairs can generally be formed from two insulated wires. Each of the insulated wires can include a conductive wire and an insulation layer. The conductive wire can be solid or stranded. The conductive wires can be formed of any suitable conductive metal, such as one or more of copper, aluminum, steel, and silver. In certain embodiments, the conductive wire can advantageously be formed of copper due to copper's high electrical conductivity relative to its volume.

As can be appreciated, stranded wire can be advantageous in certain embodiments due to the mechanical and electrical advantages exhibited by stranded wire. For example, stranded wires can exhibit increased flexibility and conductivity compared to a solid wire of identical gauge. In certain embodiments, the conductive wire can be a stranded copper wire.

Generally, the insulated wires can be of any suitable wire gauge. For example, in certain embodiments, the insulated wires can be sized in accordance with American Wire Gauge (“AWG”) standards and each wire can have a size between 18 AWG and 32 AWG. For example, the cables described herein can include eight 26 AWG insulated wires or eight 24 AWG insulated wires in certain embodiments. As can be appreciated, selection of the wire gauge can vary depending on factors such as the desired cable operating distance, the desired electrical performance, and physical parameters such as the thickness of the cable.

In certain embodiments, the insulation of the insulated wires can be formed of any suitable insulating material which can provide the desired electrical properties. For example, suitable insulation layers can be formed of dielectric materials such as polyolefins (e.g., polypropylene, polyethylene, etc.) or fluoropolymers (e.g., fluorinated ethylene propylene (“FEP”), ethylene chlorotrifluoroethylene (“ECTFE”), perfluoromethyl alkoxy (“MFA” and “PFA”), polyvinylidene fluoride (“PVDF”), etc.). In certain embodiments, the insulation layers can be formed of halogen-free polyolefins. For example, a suitable halogen-free polyolefin can be a low-smoke, zero halogen polyolefin such as polyethylene. Such low-smoke, zero halogen polyolefins can be preferred due to the desirable fire resistance characteristics of such materials. In certain embodiments, the insulation layers can be formed of high-density polyethylene (“HDPE”). In other embodiments, selection of a fluoropolymer can be advantageous due to the superior electrical properties (e.g., dielectric properties, and dissipation factors) and fire resistance properties exhibited by such materials when compared to polyolefins.

The thickness of the insulation can vary depending on the desired electrical performance. In certain embodiments, each insulated wire of a twisted wire pair can have an insulation thickness of about 0.05 mm to about 0.40 mm; in certain embodiments, about 0.10 mm to about 0.30 mm; or in certain embodiments, about 0.17 mm to about 0.25 mm. As can be appreciated, the thickness of the insulation can also vary depending on the wire gauge of the conductive wire. For example, 24 AWG insulated wires can include an insulation layer having a thickness of about 0.25 mm, while 26 AWG insulated wires can include an insulation layer having a thickness of about 0.17 mm. The insulation resistance can be about 1,000 mΩ/km or greater.

Generally, the number of twisted wire pairs can be varied depending on the data throughput required for various applications. For example, in certain embodiments, two twisted wire pairs can be included while in other certain embodiments, four twisted wire pairs can be included. The number of twisted wire pairs can influence the thickness of the cable with a cable including only four conductive wires being thinner than a similar cable constructed with eight conductive wires. The insulated wires can be twisted together to form a twisted wire pair as known in the art. Collectively, the twisted wire pairs can also be twisted to form a cable core as known in the art. Generally, the twist rates of the insulated wires can be similar to the twist rates and tolerances of known Category 5e, Category 6, Category 6A, Category 7, Category 7A, and Category 8 cables.

The improved cables 110 can further include a cable shield, such as a shield tape layer 120. The shield tape layer 120 (i.e., metallized tape) can improve the performance of the cable. As can be appreciated, a variety of other types of cable shields can also be useful for the cables described herein. Suitable cable shields can be formed of metallic foil, braided metal, woven metal, or semi-conductive polymers, but selection of the cable shield can vary depending on factors, such as the required reduction in EMI and required cable flexibility. As can be appreciated, metallized tapes and other types of cable shields (e.g., metallic shields) can attenuate electromagnetic interference (“EMI”), be a barrier to alien crosstalk, and reduce electrical noise from both outside the cable as well as from adjacent twisted wire pairs.

In certain embodiments, the shield tape layer 120 can be formed from strips of shield tape (e.g., 122a, 122b). The strips of shield tape (e.g., 122a, 122b) can surround and be longitudinally applied to the cable core, such that the overlapping region 124 can extend along the length of the cable 110. In certain embodiments, a width of the overlapping region 124 can be about 20% to about 25% of the width of the strips of shield tape (e.g., 122a, 122b). For example, in one embodiment, the width of the strips can be about 0.875 inches, while the width of the overlapping region can be about 0.200 inches. In certain embodiments, however, the width of the strips can be about 0.5 inches to about 1.25 inches; in certain embodiments, about 0.75 inches to about 1.00 inches; in certain embodiments, about 0.80 inches to about 0.95 inches; and in certain embodiments, about 0.85 inches to about 0.90 inches. Further, in certain embodiments, the width of the overlapping region can be about 0.15 inches to about 0.25 inches; in certain embodiments, about 0.175 inches to about 0.225 inches; and in certain embodiments, about 0.19 inches to about 0.21 inches.

In certain embodiments, the shield tape, or metallized tape, can generally refer to polymeric films that are metallized through application of a deposited metal such as aluminum, copper, or gold. For example, a continuous metallized polyethylene terephthalate tape (e.g., Mylar® from DuPont Teijin Films of Wilmington, DE) with an aluminum metallic coating can be a suitable metallized tape in certain embodiments. In certain embodiments, the metallic coating can be discontinuous. In certain embodiments, the shield tape can be formed from aluminum that is solid. For example, in one embodiment, the shield tape can have a 0.002 inch thick layer of polyethylene terephthalate and a 0.0015 inch thick layer of aluminum for a total thickness of 0.0035 inches. In another embodiment, the shield tape can have a 0.0005 inch thick layer of polyethylene terephthalate, a 0.0015 inch thick layer of aluminum, and a 0.0005 inch thick layer of polyethylene terephthalate for a total thickness of 0.0025 inches.

In certain embodiments, and as shown in FIGS. 4-6, the shield tape layer 120 can include two or more strips of shield tape 122a, 122b and one or more strips of splice tape 130, where each of the one or more strips of splice tape 130 can connect successive strips of shield tape 122a, 122b. While FIGS. 4-6 show the splice tape 130 on an outer surface of the strips of shield tape 122a, 122b, it will be appreciated that one or more strips of splice tape can alternatively be applied to an inner surface of strips of shield tape, and in certain embodiments, one or more strips of splice tape can be applied to both an inner surface and an outer surface of strips of shield tape.

Example splice tape described herein can be formed from high tensile strength tape having a high temperature adhesive. For example, in certain embodiments, a splice tape can be formed from a metallized polyester with a solvent acrylic adhesive. In certain embodiments, a splice tape can be formed from polyimide (e.g. Kapton® tape from DuPont). As can be appreciated, splice tape described herein can be formed from any of a variety of suitable materials.

As described herein, the splice tape 130 can have a width that is less than a width of the strips of shield tape (e.g., 122a, 122b). Specifically, the splice tape 130 can be sized such that the splice tape does not extend in the overlapping region 124 of the shield taper layer 120. Accordingly, the improved cables 110 can include a shield tape layer 120 having an overlapping region 124 that does not include the splice tape 130. For example, in such improved cables 110, the overlapping regions 124 can have a thickness that is only two times the thickness of the shield tape (e.g., 122a, 122b).

In certain embodiments, a splice tape can have a width that is less than or equal to the width of the strip of shield tape less two times the width of the overlapping region. For example, when the strip (e.g., 122a, 122b) has a width of about 0.875 inches and the overlapping region 124 has a width of about 0.200 inches, the width of the splice tape 130 can be about 0.475 inches. In certain embodiments, the width of a splice tape can be about 0.35 inches to about 0.6 inches; in certain embodiments, about 0.4 inches to about 0.55 inches; in certain embodiments, about 0.45 inches to about 0.5 inches; and in certain embodiments, about 0.47 inches to about 0.48 inches.

In certain embodiments, a splice tape can have a thickness of about 0.0005 inches to about 0.003 inches; and in certain embodiments, about 0.0022 inches. Further, a splice tape can have a length of about 1 inch to about 8 inches. In certain examples, the splice tape can have a length of about 4 inches. It will also be appreciated that a splice tape can be configured into a variety of different shapes.

As shown in the shield tape layer 220 of FIG. 7, the strips of shield tape 222a, 222b can be cut to remove the corners therefrom. With the narrower splice tape 230, a shield tape 222b having corners cut as shown in FIG. 7 can prevent corners from curling up and potentially interfering with production of the cables.

As described herein, the shield tape layer 120 can be applied longitudinally around the conductors 140 (e.g., pairs of twisted conductors). As can be appreciated, however, the strips of shield tape (e.g., 122a, 122b) can be applied around either all of the pairs of twisted conductors and/or can be applied around individual pairs of twisted conductors. In certain embodiments, certain cables meeting the requirements of Category 6, Category 6A, Category 7, Category 7A, or Category 8 cables can include a shield tape around the individual twisted wire pairs.

In certain embodiments, the cables described herein can include both a shield tape layer 120 and a metallic shield (not shown). In such embodiments, the metallic shield can surround either the shield tape layer 120 and/or the one or more conductors 140. In certain embodiments, metallic shields can be braided metallic shields and can provide about 60% or greater coverage or shielding. In certain embodiments, the cables described herein can include a braided, tinned, copper shield which provides about 60% or greater coverage.

The cables 110 described herein can further include a jacket layer (not shown) to provide mechanical durability to the cable. As can be appreciated, the jacket layer can be the outermost layer of the cable and can be formed of any suitable polymeric composition which can provide mechanical durability to the cable. In certain embodiments, however, it can be particularly advantageous to form the jacket layer from a halogen-free crosslinked polyolefin. Halogen-free crosslinked polyolefins can exhibit high durability, as necessitated for industrial applications, and do not release halogenated chemicals when burned. Generally, suitable polyolefins can vary widely and can include polyethylene, ethylene vinyl acetate (“EVA”), ethylene acrylic acid, ethylene methyl acrylate, ethylene ethyl acrylate, and ethylene butyl acrylate copolymers. In certain embodiments, the jacket layer can further include fire retardant additives, such as one or more of magnesium hydroxide and aluminum trihydrate, which can improve the flame performance of the jacket layer without detrimentally impacting the mechanical performance of the jacket. In certain embodiments, the jacket layer can be crosslinked via an electron beam (“e-beam”) curing process or any of a variety of other suitable crosslinking processes.

In certain embodiments, insulation layers and/or a jacket layer can include additives such as processing aids or colorants. For example, it is customary to include blue, green, brown, and orange colorants in the insulation of the insulated wires to aid in the termination of pairs of twisted conductors. In certain embodiments, colorants can also be included in the jacket layer.

As can be appreciated, in certain embodiments, the cables described herein can further include additional components. For example, in certain embodiments, a cable separator (not shown), such as a cross-web, can be included to provide additional mechanical and electrical separation between conductors (e.g., twisted wire pairs). Use of a cable separator can improve the electrical performance characteristics of the cable and can, for example, enable the cable to meet the performance requirements of Category 6, Category 6A, Category 7, Category 7A, or Category 8 cables.

In certain embodiments, suitable cable separators can be formed of halogen-free materials such as a low-smoke, zero halogen, polyolefin such as polyethylene. Generally, the cable separator can be formed in any suitable shape such as a cross-web separator, tape separator, star separator, etc. In certain embodiments, the cable separator can be foamed to improve fire resistance and electrical performance.

Methods of forming the cables can include providing a cable core including one or more conductors. For example, the cables can be formed by twisting insulated wires together to form both pairs of twisted conductors and the cable core. A shield tape layer can then be longitudinally wound around the cable core, such that an overlapping region extends along the length of the cable.

Methods of forming the cables can also include connecting successive strips of the strips of shield tape with one or more strips of splice tape, each of the one or more strips of splice tape having a width that is less than a width of each of the two more strips of shield tape. In certain embodiments, as described herein, splice tape can be applied to strips of shield tape such that the splice tape does not extend into the overlapping region of the shield taper layer. In certain embodiments, splice tape can be positioned centrally relative to the width of the strips of shield tape. In certain embodiments, a jacket layer can then be extruded and cured through a process as described herein (e.g., e-beam curing). In certain embodiments, the method can be performed continuously.

### Examples

Cables were pulled through a tape former and insert to measure the pull force required to connect two strips of shield tape with a splice tape. Each cable was formed with a core having four pairs of twisted conductors, where each individual wire was coated but not shielded, and shield tape joined by splice tape. The shield tape was aluminum foil-backed/sandwiched polyethylene terephthalate tape (0.5 mil PET/1.5 mil aluminum/0.5 mil PET) and the splice tape was 952S metallized polyester acrylic tape (2.2 mil silver). Example 1, a comparative example, was formed from two strips of shield tape connected by a strip of splice tape having a width of 0.950 in. Example 2, an inventive example, was formed from two strips of shield tape connected by a strip of splice tape having a width of 0.475 in.

For each example, the splice tape was applied manually to join the two strips of shield tape. The strips of shield tape, connected by the splice tape, were inserted in the tape former and manually pushed through the tape former opening and through the insert, such that the shield tape stuck out just enough to be grabbed by the tester's jaw and not so much that the splice tape has passed through the tape former opening and insert. The four pairs of twisted conductors, i.e., the core, were manually pushed through the tape former opening and the insert (sliding inside the shield tape) until the core and shield tape were clamped in the tester's jaw. The automatic tester was then started, and the tester pulled the core and shield tape through the tape former and insert until the splice tape passed through the tape former opening and insert. The maximum load was then recorded.

TABLE 1
Results from Testing of Cables with
Splice Tape Having Different Widths

| | Splice | | Pull Force | | 95% |
|---|---|---|---|---|---|
| | Tape | No. | (Mean | Standard | CI |
| | Width | of | Value, | Deviation | Range |
| Example | (in.) | Tests | lbs) | (lbs) | (lbs) |
| Example 1 | 0.950 | 6 | 7.067 | 0.484 | (6.558, 7.575) |
| (Comparative) | | | | | |
| Example 2 | 0.475 | 5 | 4.520 | 0.526 | (3.867, 5.173) |
| (Inventive) | | | | | |

As shown in Table 1, the pull force required to pull the cable of Example 2 through the tape former and the insert, where Example 2 had a narrower splice tape width, was less than that which was required to pull the cable of Example 1, which had a broader tape splice width. Specifically, Example 2 required 2.547 lbs. less pull force than Example 1. In addition to a narrow splice tape avoiding an overlapping region and allowing for a reduced cable thickness, by requiring less pulling force, cables utilizing a narrower splice tape width can also be formed more efficiently and economically.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of ordinary skill in the art. Rather it is hereby intended the scope be defined by the claims appended various embodiments. The scope is, of course, not limited to the examples or embodiments set forth herein, but can be employed in any number of applications and equivalent articles by those of hereto.

What is claimed is:

1. A cable comprising:
a cable core including one or more conductors; and
a shield tape layer comprising:
two or more strips of shield tape surrounding the cable core, wherein the strips of shield tape are longitudinally applied to the cable core such that an overlapping region extends along a length of the cable; and
one or more strips of splice tape, each of the one or more strips of splice tape connecting successive strips of shield tape and being sized such that the one or more strips of splice tape do not extend into the overlapping region of the shield tape layer.

2. The cable of claim 1, wherein the one or more strips of splice tape have a width that is less than a width of each of the two more strips of shield tape.

3. The cable of claim 1, wherein a width of the overlapping region is about 20% to about 25% of the width of each of the two more strips of shield tape.

4. The cable of claim 1, wherein a width of the one or more strips of splice tape is less than or equal to the width of each of the two more strips of shield tape less two times a width of the overlapping region.

5. The cable of claim 1, wherein each of the one or more strips of splice tape has a width of about 0.35 inches to about 0.6 inches.

6. The cable of claim 5, wherein each of the one or more strips of splice tape has a width of about 0.45 inches to about 0.5 inches.

7. The cable of claim 1, wherein each of the one or more strips of splice tape has a length of about 1 inch to about 8 inches.

8. The cable of claim 1, wherein each of the one or more strips of splice tape has a thickness less than about 0.003 inches.

9. The cable of claim 1, wherein each of the one or more strips of splice tape has a thickness of about 0.0005 inches to about 0.003 inches.

10. The cable of claim 1, further comprising a jacket layer.

11. The cable of claim 1, wherein the cable is a local area network (LAN) cable.

12. The cable of claim 1, wherein the cable meets the requirements of ANSI/TIA 568.2-D (2018) for Category 6A cables.

13. The cable of claim 1, wherein the shield tape is an alien crosstalk barrier.

14. The cable of claim 1, wherein the shield tape is formed from aluminum.

15. The cable of claim 14, wherein the aluminum is solid or discontinuous.

16. The cable of claim 1, wherein the splice tape is a high tensile strength tape having a high temperature adhesive.

17. A method of forming a cable, the method comprising:
providing a cable core including one or more conductors;
longitudinally wrapping two or more strips of shield tape around the cable core such that an overlapping region extends along a length of the cable; and
connecting successive strips of the two or more strips of shield tape with one or more tape joints, each of the one or more strips of splice tape being sized such that the one or more strips of splice tape do not extend into the overlapping region of the shield tape layer.

18. The method of claim 17, wherein the each of the one or more strips of splice tape has a width of about 0.45 inches to about 0.5 inches and a length of about 1 inch to about 3 inches; and
wherein the one or more strips of splice tape have a width that is less than a width of each of the two more strips of shield tape.

19. The method of claim 17, wherein the one or more strips of splice tape are positioned centrally relative to the width of the two more strips of shield tape.

20. The method of claim 17, wherein the method is performed continuously.
